(19) United States
(12) Patent Application Publication
(10) Pub. No.: US 2024/0035714 A1
(43) Pub. Date: Feb. 1, 2024

(54) SYSTEM AND METHOD FOR FEEDBACK-BASED NUCLEATION CONTROL

(71) Applicant: XEROX CORPORATION, NORWALK, CT (US)

(72) Inventors: Krishnan Thyagarajan, Sunnyvale, CA (US); Christopher Somogyi, Wimberley, TX (US)

(21) Appl. No.: 17/876,010

(22) Filed: Jul. 28, 2022

(51) Int. Cl. F25B 21/00; G05D 23/19

(52) U.S. Cl. CPC F25B 21/00; G05D 23/1919; G05D 23/1917

(57) ABSTRACT

A method for feedback-based supercooling. One or more composition characteristics of an object are identified. A value for the identified composition characteristics are determined. One or more parameters are determined for one or more fields, including electromagmentic, magnetic or electric fields based on the determined values for one or more of the identified composition characteristics. The object is supercooled by applying the fields to the object using the parameters. One or more of the composition characteristics or characteristics of the field are monitored during application of the fields via at least one feedback sensor and one or more of the parameters for the field are adjusted based on the monitored composition characteristics or field characteristics.

### FIELD

This application relates in general to temperature control and in particular, to a system and method for feedback-based supercooling.

### BACKGROUND

Freezing is commonly used to preserve and store food and other organic material. Freezing involves keeping an object at sub-zero temperatures to minimize microbial damage of that object. However, during the process of freezing, unwanted chemical composition changes, nutritional damage and physical damage can occur in the object. Freezing is also time consuming and can be restricted to particular organic object, rendering the process unavailable for some oil-based foods and objects with low water content. Furthermore, when the object is to be subsequently consumed, a thawing time needs to be accounted for before the object can be utilized. On the other hand, refrigeration reduces physical degradation, but induces rapid microbial and nutritional damages, thereby rendering refrigeration ineffective for long-term storage.

The restrictions of freezing, including freeze drying, and refrigeration for preservation can both be overcome by supercooling, while permitting the advantages of both techniques to be present. Currently used supercooling techniques utilize fields, such as magnetic and electromagnetic fields, as described in U.S. Pat. No. 10,588,336, to Jun, to help preserve the physical, nutritional, and sensory characteristics of an object, such as a biological item, while subjecting the object to a temperature below the freezing point of water without freezing the object itself. This is enabled by the suppression or prevention of phase change of both intracellular and intercellular water in the intended object. The fields can include a pulsed/oscillating electric field, pulsed/oscillating magnetic field, or a combination of fields to reorient and induce vibration of water molecules in the object (among other physico-chemical controls), thus suppressing or preventing the formation of ice from the water molecules.

While applicable to many kinds of objects, supercooling is of a particular interest in preserving biological items, such as food, organs, produce, tissues, stem cells, embryos, vaccines, water-based medicines, and blood, with achieving and maintaining a supercooled state of the biological item being possible due to oscillating/pulsed magnetic fields or oscillating/pulsed electric fields or a combination thereof, which prevents phase change, including nucleation or freezing of the water contained in the biological item. However, conventional techniques for supercooling do not account for differences in the biological items' characteristics and do not allow for a near-real-time assessment of the status of the supercooled object to provide a closed-loop feedback, thus complicating achieving a desired result. In particular, achieving a state of supercooling requires an approach tailored to individual characteristics of the objects being supercooled. For instance, based on the composition of a specific object, different field characteristics such as field strength, frequency, phase, and waveform, are necessary. Determining the correct characteristics and their values in order to achieve supercooling and prevent ice-nucleation can be difficult to determine due to many factors, including size, shape, and content of the object, and many of the general public may experience difficulty in maintaining supercooling conditions based on a lack of knowledge of object composition and lack of monitoring capabilities. In addition, the fields that were appropriate previously, may no longer be suitable for continuing the supercooling process.

Accordingly, a feedback system to monitor the object and adjust parameters of the field to reach and maintain supercooling without freezing of the object is needed. Preferably, the feedback system tailors the field applied to achieve supercooling based on characteristics of the object being supercooled, as the ability to change the supercooling characteristics on the fly is important to obtain optimum energy-efficient supercooling.

### SUMMARY

A feedback system that identifies characteristics of an object and utilizes the characteristics to initiate and adjust a field applied to the object is provided. In one embodiment, the system leverages machine learning to automatically identify a condition of the object and adjust the supercooling parameters. Sensors are utilized during supercooling to monitor a condition of the object being supercooled. Specifically, characteristics of the object are measured at different points, areas, or volumes on the object and the measurements are used to determine whether supercooling is being achieved or whether the object is starting to freeze. Based on the measurements, parameters of the field can be adjusted to ensure supercooling of the object without freezing.

An embodiment provides a system and method for feedback-based supercooling. A composition of an object is determined by identifying one or more composition characteristics. A value for each identified composition characteristics is determined. One or more parameters for fields including at least one of amplitude, frequency, waveform, phase, and duration are determined based on the values for the identified composition characteristics. The fields include one or more of electromagnetic fields or magnetic or electric fields. The object is supercooled by applying the fields to the object using the parameters. One or more of the composition or field characteristics are monitored during and subsequent to the application of the fields and one or more of the parameters for the fields are adjusted based on the monitored composition or field characteristics.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for feedback-based nucleation control in accordance with one embodiment.

FIG. 2 is a flow diagram showing a method for feedback-based nucleation control in accordance with one embodiment.

FIG. 3 is a block diagram showing, by way of example, a device for feedback-based nucleation control.

### DETAILED DESCRIPTION

Food is often frozen or freeze dried to ensure preservation for long periods of time, while maintaining nutrients. However, during the freezing or freeze drying processes, chemical agents may be introduced and food may undergo chemical compositional changes. Further, freezing, including freeze drying, is not appropriate or effective for all types of objects. In lieu of freezing or freeze drying, supercooling can be applied to food and other water-containing objects, such as organic matter and biological items. During supercooling, the water-containing objects are preserved by cooling the objects to a temperature below the freezing point of water without initiating the formation of ice within or on the object. However, ensuring that the water in the object does not freeze, by turning to ice, can be difficult and the object should be monitored closely. A feedback system can monitor characteristics or conditions of an object under supercooling conditions, determine new parameters for the supercooling fields applied, and make adjustments to the fields based on the new parameters.

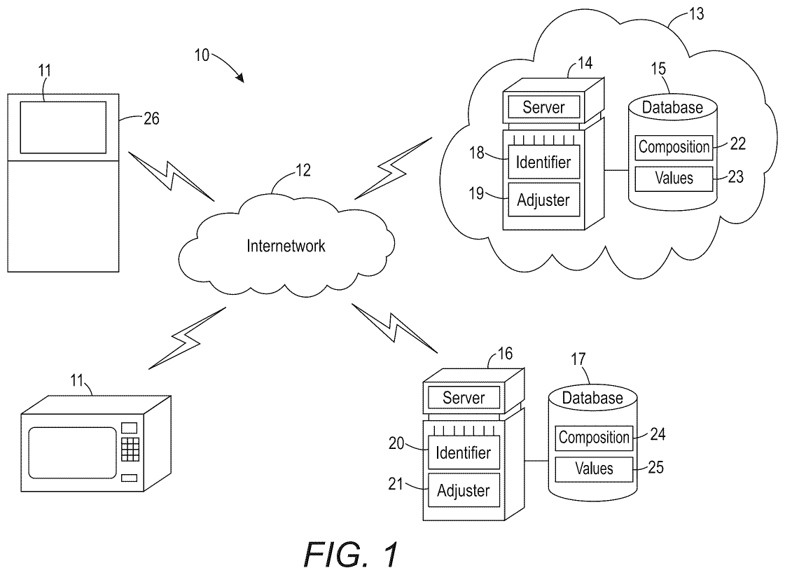

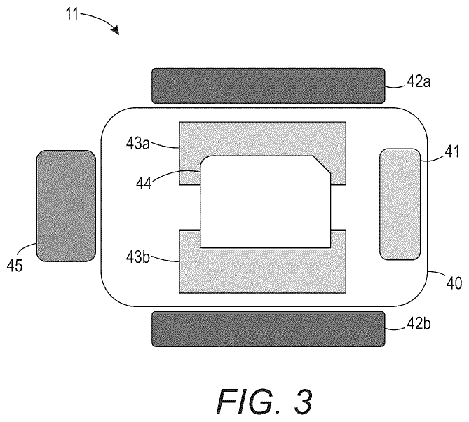

Utilizing a feedback system during supercooling helps prevent phase change of an object to a solid, including nucleation of water in an object, in a much more optimum manner. FIG. 1 is a block diagram showing a system 10 for feedback-based nucleation control in accordance with one embodiment. A supercooling device 11 can supercool an object to a temperature below the freezing point of water or the freezing point of that object without freezing the object by applying one or more fields to the object, including magnetic, electric, and electromagnetic fields. The supercooling device 11 can be a standalone device or can be incorporated into an appliance, such as a refrigerator or another freezer 26, and is described in detail below with respect to FIG. 3. When incorporated into another appliance that has a cooling function, the supercooling device utilizes that cooling function to lower the temperature of the water. However, when used as a standalone device, the supercooling device can include a cooling system to lower the temperature of the water to a range of −1° C. to −30° C. In a further embodiment, components of the supercooling device 11 can be included in a housing and together, inserted into an appliance.

The supercooling device 11 communicates with a feedback server 14, 16 via an internetwork 12, such as the Internet or cellular network, to obtain and adjust parameters of the field based on the obtained characteristics. In one embodiment, the feedback server 14 can be a cloud-based server. Alternatively, the server 16 can be locally or remotely located with respect to the supercooling device 11. The feedback server 14, 16 can include an identifier 18, 20 and an adjuster 19, 21. The identifier 18, 20 can utilize measurements for characteristics of the object obtained from the supercooling device 11 to determine an identity or classification of the object based on known composition values 22, 24 of objects stored in a database 15, 17 associated with the server 14, 16. Machine learning can also be used in lieu of or in addition to a look up table of compositions and identities or classifications. In a further embodiment, identification or classification of an object can occur on the supercooling device 11, such as via a processor, which is described in detail below with respect to FIG. 3.

The adjuster 19, 21 utilizes data obtained from the supercooling device 11 regarding the object and the field to determine whether the field should be adjusted to ensure an appropriate supercooling temperature is reached, without allowing nucleation of ice via the water content in the object. The adjustment can be determined using characteristic values 23, 25 for the object and parameter values for the field, which are stored by the databases 15, 17 to determine new parameter values for the field. In a further embodiment, ranges of object characteristics and field parameters can be stored on the supercooling device 11 for use in adjusting the supercooling fields applied to an object. Alternatively, machine learning can also be used to determine and adjust field parameters in lieu of a stored look up table of characteristic values and parameters.

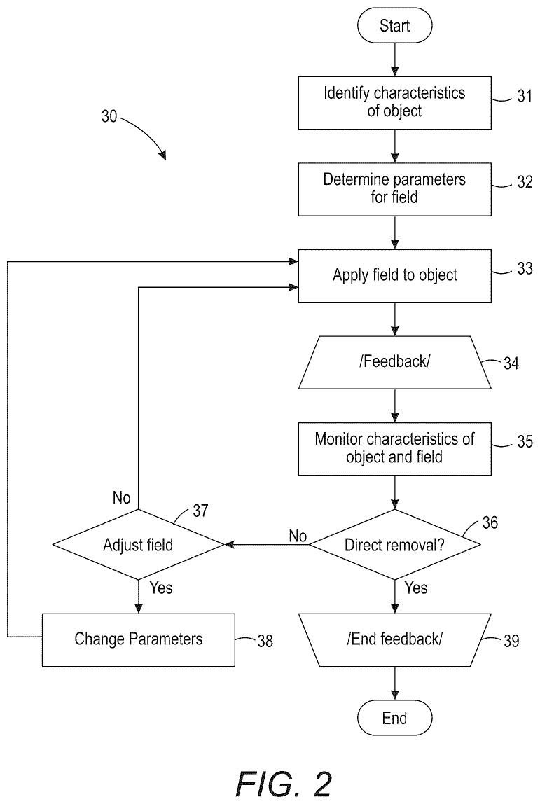

The ability to automatically determine a composition of an object, and determine and adjust parameters for supercooling helps to maintain supercooling conditions of the object, while preventing ice-nucleation and freezing of the object. FIG. 2 is a flow diagram showing a method 30 for feedback-based supercooling in accordance with one embodiment. An object to be supercooled is placed into a supercooling device. A composition or particular characteristics of the object can be identified (step 31) via sensors. For example, one or more sensors can send signals towards the object and information about the object is obtained via the signal, which is returned back to the sensor. Passive and active sensors can be used, including imaging and reflective sensors, as well as electrocurrent sensors, optical sensors, chemical sensors, electrochemical sensors, acoustic sensors, and hyperspectral imaging. Measures for characteristics, such as water content, fat content, density, size, and shape, as well as other characteristics, can be obtained via the sensors. For example, a resistance of a food object can be measured using two electrodes to determine a fat content of the object or hyperspectral imaging can be used to determine a surface roughness or chemical composition of the object. The identified characteristics can be used to classify the object as a type of food or identify the specific food object.

In one embodiment, the identified characteristics can be used to classify the object or determine an identity of the object. A classification can group the object into a category of biological items or food, including grains, meat, seafood, vegetables, dairy or dairy products, fruit, or beverages, including water-based or milk-based beverages, while an identity can include a name of the object, such as an orange, which belongs to the category of fruit. For example, a piece of meat can be distinguished from a vegetable based on having lower water content, more potassium, more saturated fat, and more zinc. The piece of meat can be further identified as pork based on a fat content difference from chicken and beef.

Classification or identification of an object can occur via a camera, using a look up table, be provided by a user, or determined via machine learning. When used, a camera can obtain an image of the object that can be compared with a database of images to determine an identity of the object. The look up table can include characteristics, values for the characteristics, and identities or categories for the object based on the identified characteristics and values.

If user provided, the user can provide the characteristics of the object or an identity of the object by entering the characteristics or identity into the supercooling device or an application for the supercooling device. Alternatively, during machine learning, values for the characteristics are input to classify the object as having a particular identity or belonging to a particular category.

Initial parameters for a field applied during supercooling can be determined (step 32) based on the characteristics of the object, or the identity or classification of the object, if known. Specifically, when an identity of the object is not known, one or more of the characteristics can be used to determine a type of field and initial parameters for the determined field. The field can include a magnetic field, electric field, an electromagnetic field, or a combination of fields. Other types of fields are possible.

Meanwhile, the field parameters can include amplitude, frequency, phase, waveform, and duration, as well as other types of parameters. Values for the parameters can be determined using a look up table, which can provide field parameter values for objects based on a characteristic or a combination of characteristics, or based on an identity or classification of the object. In a further embodiment, machine learning can be used to determine the initial field parameters. The learning can be performed based on data sets of the characteristic values and parameters for fields to be applied to each of the different objects. Once the parameters are determined, the field is then applied (step 33) to the object based on the values of the parameters.

Prior to, concurrently with, or subsequently, cooling is applied (step 34) to the object to initiate supercooling. The cooling can be produced by a compressor in a cooling system, such as a refrigeration or freezer system that can also include a condenser and evaporator. In one example, traditional refrigeration or freezer systems can be used. Other types of cooling systems can also be used. At a minimum, the cooling system should be able to cool the beverage to a temperature between −1° C. to −20° C.

To maintain supercooling conditions, such that the object does not begin to freeze, a feedback system is run (step 34). In one embodiment, desirable supercooling conditions can include a temperature range of about −1° C. to −20° C. While undergoing supercooling, the object can be monitored (step 35) continuously or at predetermined time periods to determine a condition of the object. For example, characteristics of the object can be monitored, including temperature, impedance, hyperspectral imaging, acoustic sensing, and visible and infrared imaging. The object can be monitored at different spatial points at different times or at the same time. Characteristics of the applied field can also be monitored (step 35), including wavelength, frequency, phase, amplitude, waveforms, and duration. If at any time, removal of the object from the supercooling device is detected (step 36), monitoring of the object ends and the feedback system and supercooling process is completed for that object (step 39).

However, if the object remains in the supercooling device under supercooling conditions, the monitored characteristics of the object and field can be used to determine whether the field needs to be adjusted (step 37). If the object is determined to be under appropriate supercooling conditions, such that the object reaches a temperature between −1° C. and −20° C., and no nucleation of the water molecules in the object has commenced, no adjustments may be necessary and the field is continued (step 33). For example, ultrasonic sensors can be used to identify air pockets within an object and thus, a density of the object. A dense object, like a carrot, has fewer air pockets for water than less dense objects, such as lettuce. If nucleation or freezing is beginning, the density of the carrot can change as the water in the air pockets freeze and expansion between the cells of the carrot occurs. The propagation of sound through ice and water are different as well, thus acoustic sensors can be used to determine the beginning of the formation of ice (if it occurs).

If the object appears to be close to or actually undergoing nucleation, adjustments to the field parameters should be made (step 38). The parameter adjustments can include a change in amplitude, frequency, phase, waveform, wavelength, and duration of the field, which can affect mobility, physical movement or ability of phase-change of water molecules in the object to prevent or reverse nucleation. The field changes can be made manually or automatically. In one embodiment different formulas can be used to determine new parameter values based on the monitored characteristics of the object, as well as a graph of object characteristics and calibration of the fields. The chart can include values for the listed characteristics with standard deviations and known progression of time with temperatures for each object with a particular characteristic or combination of characteristics to achieve supercooling. In a different embodiment, machine learning can be used to determine new values for the field parameters.

Returning to the above example, after the carrot is determined to be undergoing nucleation or freezing, the field parameters can be adjusted. New values of the parameters can be determined via machine learning or a graph. For instance, if freezing is occurring, the frequency and wavelength of the field application to the carrot may be increased to result in additional mobility of the water molecules to prevent freezing. After the parameters are changed, the field is applied (step 33) to the object using the adjusted parameters and the feedback process continues (step 34). For example, a magnetic field can be changed by moving the magnets closer to or away from the object, or moving the magnets relative to one another. Movement of the magnets can be manual or automated.

The device used to perform supercooling can vary in size depending on the objects to be supercooled. FIG. 3 is a block diagram showing a top view of a device 11 for feedback-based supercooling in accordance with one embodiment. The supercooling device 11 can include a receptacle 40 in which an object 44 is placed to undergo supercooling. The receptacle 40 can include a container, pan, or other type of receptacle for holding the object 44. In one embodiment, the receptacle 40 is placed into a standalone housing (not shown), similar to a microwave, to initiate supercooling or alternatively, can be incorporated into an appliance, such as a refrigerator.

One or more field generators 42a,b, 43a,b can be positioned with respect to the receptacle 40. The field generators can each include a magnet, electrode, wires, electromagnets, or other material systems, such as 2D materials, including for example, graphene, van-der-waals layered materials or organic conductive polymers. For example, electrodes 43a,b can be positioned on a bottom side of the receptacle, along an interior surface, to generate a pulsed electric field. Other positions of the electrodes are possible, including on opposite sides (not shown) of the receptacle 40. When placed in a position other than the bottom of the receptacle, the electrodes can be affixed to walls of the standalone housing or walls of a housing, such as an appliance. The electrodes can be positioned to contact the object or in a further embodiment, can be placed remotely from the object.

The supercooling device 11 can also include at least one magnet 42a, b, such as an electromagnet, a permanent magnet, or a combination of magnets, to generate an oscillating magnetic, electric or electromagnetic field. Time-varying magnetic fields can be used to create electric fields and vice-versa. The magnets can be positioned along one or more sides of the receptacle 40, or can be affixed to the receptacle itself or the housing in which the receptacle is placed. In a further embodiment, the magnets can be remotely located from the receptacle and the field emitted from the magnets can be applied to the object via one or more transducers.

Further, at least one closed-loop monitoring sensor 41 can be provided adjacent to the receptacle on one or more sides. Alternatively or in addition, a sensor can be affixed to the housing, on an interior surface, in which the receptacle is placed for supercooling. The monitoring sensors can include imaging and reflective sensors, electrocurrent sensors, chemical sensors, electric sensors, acoustic sensors, optical sensors, electrochemical sensors, thermal sensors and imagers, and hyperspectral sensors. However, other types of sensors are possible.

An electrical control unit 45 can be a processor that is interfaced to the sensors 41, magnets 42a,b, and electrodes 43a,b to communicate during the feedback process. Specifically, the processor can determine an identity of or classify an object for supercooling based on measurements from the sensors 41, as well as identify parameters for the field to be applied based on the identity or classification. The processor can also instruct the sensors 41 to measure characteristics of the object undergoing supercooling and in turn, receive the measured values as feedback for determining if new parameters of the field are needed and if so, values of the parameters. Based on the feedback from the sensors, the processor can communicate the new parameter values with the magnets and electrodes to change the field applied to the object for changing the supercooling conditions.

In a further embodiment, the processor can obtain data from the sensors, electrodes, and magnets for providing, via a wireless transceiver included in the device, to a cloud-based server for determining an identity or classification of the object, determining initial parameters for the field, and identifying new field parameters for adjusting the field. When performed in the cloud, the data set of object identities and classifications, initial parameters, and guidelines for adjusted parameters can be utilized by different users. In contrast, when the processor of the supercooling device performs such actions, the data sets are specific to that supercooling device.

While the description above focuses on supercooling biological items, such as water-containing objects that are at least partially derived from a living entity or artificially created to at least partially resemble part of a living entity, the supercooling device and process can also be applied to different kinds of objects, including raw, preserved or cooked foods, blood, embryos, vaccines, probiotics, medicines, sperm, tissue samples, plant cultivars, cut flowers and other plant materials, biological samples of plants, animal, microbial, and fungal materials, non-biologicals, such as hydrogel materials, material that can be impacted by water absorption, such as textiles, nylons and plastic lenses and optics, fine instruments and mechanical components, heat exchangers, and fuel, as well as carbonated beverages as described in commonly-assigned U.S. Patent application, entitled “System and Method for Feedback-Based Beverage Supercooling,” Ser. No. ______, filed Jul. 28, 2022, pending; ice as described in commonly-assigned U.S. Patent application, entitled “System and Method for Controlling Crystallized Forms of Water,” Ser. No. ______, filed Jul. 28, 2022, pending; organic items as described in commonly-assigned U.S. Patent application, entitled “Feedback-Based Device for Nucleation Control,” Ser. No. ______, filed Jul. 28, 2022, pending, colloids as described in commonly-assigned U.S. Patent application, entitled “System and Method for Feedback-Based Colloid Phase Change Control,” Ser. No. ______, filed Jul. 28, 2022, pending; agriculture as described in commonly-assigned U.S. Patent application, entitled “System and Method for Controlling Cell Functioning and Motility with the Aid of a Digital Computer,” Ser. No. ______, filed Jul. 28, 2022, pending; lab grown material, including meat, as described in commonly-assigned U.S. Patent application, entitled “System and Method for Controlling Cellular Adhesion with the Aid of a Digital Computer,” Ser. No. ______, filed Jul. 28, 2022, pending; and food as described in commonly-assigned U.S. Patent application, entitled “System and Method for Metamaterial Array-Based Field-Shaping,” Ser. No. ______, filed Jul. 28, 2022, pending the disclosures of which are incorporated by reference. Further, a receptacle packaging can be used to hold objects to prevent the object from touching electrode contacts as described in commonly-assigned U.S. Patent application, entitled “An Electrode Interfacing Conductive Receptacle,” Ser. No. ______, filed Jul. 28, 2022, pending, the disclosure of which is incorporated by reference.

While the invention has been particularly shown and described as referenced to the embodiments thereof, those skilled in the art will understand that the foregoing and other changes in form and detail may be made therein without departing from the spirit and scope of the invention.

What is claimed is:

1. A method for feedback-based supercooling, comprising:
identifying one or more composition characteristics of an object;
determining a value for the identified composition characteristics;
determining for one or more fields one or more parameters each comprising one of amplitude, frequency, wavelength, phase, waveform, and duration based on the determined values for one or more of the identified composition characteristics, wherein the fields comprise one or more of electromagnetic fields or magnetic or electric fields;
supercooling the object by applying the field to the object using the parameters via one or more field generators; and
monitoring one or more of the composition characteristics or characteristics of the field during application of the fields via at least one feedback sensor, wherein one or more of the parameters for the field are adjusted based on the monitored composition characteristics or field characteristics.

2. A method according to claim 1, further comprising:
determining a category or identity of the object based on the identified composition characteristics and values for the identified composition characteristics.

3. A method according to claim 2, wherein the category or identity is determined via one of machine learning, utilizing a look up table, and provided by a user.

4. A method according to claim 1, further comprising:
controlling the supercooling of the object based on the field with the adjusted parameters.

5. A method according to claim 1, wherein each feedback sensor comprises one of an imaging sensor, reflective sensor, electrocurrent sensor, electrocurrent sensor, chemical sensor, electric sensor, acoustic sensor, optical sensor, electrochemical sensor, thermal sensor, and hyperspectral imaging sensor.

6. A method according to claim 1, wherein the object is supercooled to a temperature between −1° C. and −20° C.

7. A method according to claim 1, wherein the field generators each comprise an electrode, magnet, wires, electromagnets, or other material systems, such as 2D materials.

8. A method according to claim 1, wherein the field affects mobility, physical movement or ability of phase-change of water molecules within the object.

9. A method according to claim 1, further comprising:
determining that the object is undergoing nucleation based on the monitored characteristics.

10. A method according to claim 9, wherein the field with the adjusted parameters prevents further nucleation of the object.

11. A method for feedback-based supercooling, comprising:
identifying one or more composition characteristics of an object;
determining a value for the identified composition characteristics;
determining one or more parameters for a field comprising one or more of electromagnetic fields or magnetic or electric fields;
supercooling the object by applying the field to the object using the parameters via one or more field generators;
monitoring one or more of the composition characteristics or characteristics of the field during application of the fields via at least one feedback sensor; and
adjusting one or more of the parameters for the field based on the monitored composition or field characteristics.

12. A method according to claim 11, further comprising:
determining a category or identity of the object based on the identified composition characteristics and values for the identified composition characteristics.

13. A method according to claim 12, wherein the category or identity is determined via one of machine learning, utilizing a look up table, and provided by a user.

14. A method according to claim 11, further comprising:
controlling the supercooling of the object based on the field with the adjusted parameters.

15. A method according to claim 11, wherein each feedback sensor comprises one of an imaging sensor, reflective sensor, electrocurrent sensor, electrocurrent sensor, chemical sensor, electric sensor, acoustic sensor, optical sensor, electrochemical sensor, thermal sensor, and hyperspectral imaging sensor.

16. A method according to claim 11, wherein the object is supercooled to a temperature between −1° C. and −20° C.

17. A method according to claim 11, wherein the field generators each comprise an electrode, magnet, wires, electromagnets, or other material systems, such as 2D materials.

18. A method according to claim 11, wherein the field affects mobility, physical movement or ability of phase-change of water molecules within the object.

19. A method according to claim 11, further comprising:
determining that the object is undergoing nucleation based on the monitored characteristics.

20. A method according to claim 19, wherein the field with the adjusted parameters prevents further nucleation of the object.
